(19) United States
(12) Patent Application Publication
(10) Pub. No.: US 2023/0332386 A1
(43) Pub. Date: Oct. 19, 2023

(54) WATER CONVEYANCE IMPLEMENT

(71) Applicant: LIXIL Corporation, Tokyo (JP)

(72) Inventor: Fumiyasu ISHIGURO, Koto-ku, Tokyo (JP)

(73) Assignee: LIXIL Corporation, Tokyo (JP)

(21) Appl. No.: 18/025,598

(22) PCT Filed: Aug. 2, 2021
(86) PCT No.: PCT/JP2021/028642

§ 371 Date: Mar. 9, 2023

(30) Foreign Application Priority Data
Nov. 20, 2020 (JP) 2020-193558

(51) Int. Cl. E03C 1/042; E03C 1/04

(52) U.S. Cl. CPC E03C 1/042; E03C 1/0403; E03C 1/0408

(57) ABSTRACT

Provided is a water conveyance implement that can have an excellent outer appearance, without molding a cover portion.

A water conveyance implement includes a main body portion in which a water passage for hot/cold water is formed. Pressure higher than supply pressure of the hot/cold water to the water passage during flow acts on the water passage, the main body portion is formed by engineering plastic, and a plated portion is formed on an outer surface of the main body portion itself.

### CROSS REFERENCE TO RELATED APPLICATIONS

This application is a national stage application under 35 U.S.C. 371 of International Application No. PCT/JP2021/028642, filed Aug. 2, 2021, which claims the priority of Japanese Application No. 2020-193558, filed Nov. 20, 2020, the entire contents of each priority application of which is incorporated herein by reference.

### FIELD OF THE DISCLOSURE

The present disclosure relates to a water conveyance implement.

### BACKGROUND OF THE DISCLOSURE

There has been proposed a technique of using resin to mold a water conveyance implement in which a water passage for hot/cold water is formed. For example, Patent Literature 1 below describes a water conveyance implement having a main body functional portion molded using resin with excellent pressure resistance strength. A cover portion is integrally molded on the outer surface of the main body functional portion, using resin such as ABS resin to which plating easily adheres. With the outer surface of the cover portion plated, the water conveyance implement can have excellent outer appearance.
Patent Literature 1: JP 2001-220781 A

### SUMMARY OF THE DISCLOSURE

According to the water conveyance implement described above, the cover portion is molded, and then the outer surface thereof is plated. There has been a demand for omission of the molding of the cover portion, so that the water conveyance implement can be more easily manufactured.

The present disclosure has been made in view of the above, and an object of the present disclosure is to provide a water conveyance implement having excellent outer appearance without molding the cover portion.

A water conveyance implement of the present disclosure includes a main body portion in which a water passage for hot/cold water is formed. Pressure higher than supply pressure of the hot/cold water to the water passage during flow acts on the water passage, the main body portion is formed by engineering plastic, and a plated portion is formed on an outer surface of the main body portion itself.

### BRIEF DESCRIPTION OF THE FIGURES

FIG. 1 is a perspective view illustrating a state where a hot/cold water mixing faucet is attached to a bathroom.

FIG. 2 is a plan view illustrating the hot/cold water mixing faucet.

FIG. 3 is a cross-sectional view illustrating an attachment leg.

FIG. 4 is a cross-sectional view illustrating a shower elbow.

### DETAILED DESCRIPTION OF THE DISCLOSURE

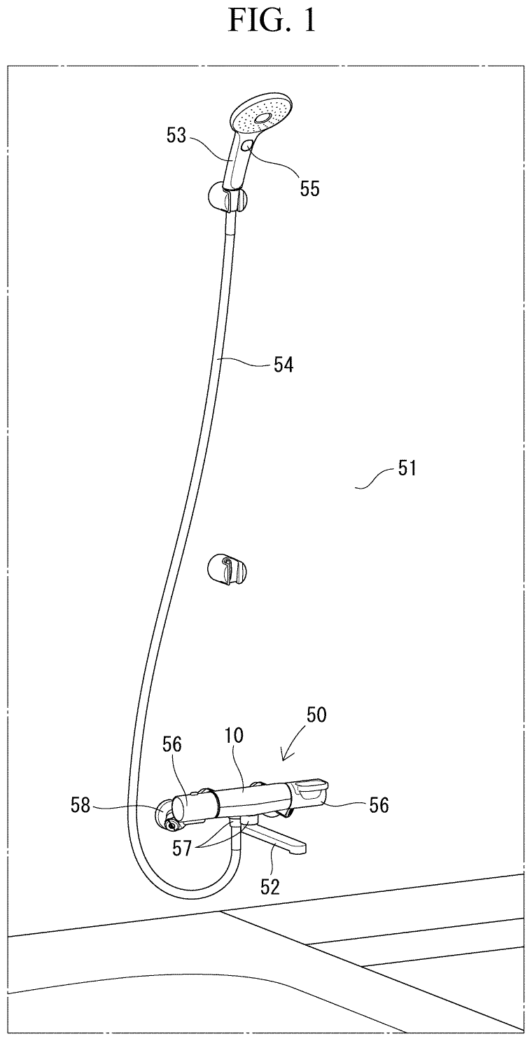

As illustrated in FIGS. 1 to 4, a hot/cold water mixing faucet 50 includes a water faucet main body 10, attachment legs 20, and a shower elbow 30. The water faucet main body 10, the attachment legs 20, and the shower elbow 30 serve as a water conveyance implement in which water passages 17, 25, and 36 are formed.

As illustrated in FIG. 1, the hot/cold water mixing faucet 50 is of a wall-attached type attached to a wall surface 51 of a bathroom. The hot/cold water mixing faucet 50 mixes therein hot water and cold water supplied from the back side of the wall surface 51 of the bathroom, and discharges the resultant water through a water outlet 52 and a shower head (discharge portion) 53. The water outlet 52 extends forward from the water faucet main body 10. The shower head 53 is connected to the water faucet main body 10 through a hose 54. The shower head 53 has a temporary water stop function. The shower head 53 includes an operation switch 55 and a water stop valve (not illustrated). By operating the operation switch 55, water discharge from the shower head 53 can be temporarily switched between ON and OFF.

As illustrated in FIG. 1, the water faucet main body 10 is provided with two handles 56. By operating one of the handles 56, the temperature of the discharged hot/cold water can be adjusted. By operating the other one of the handles 56, water discharge from the water outlet 52 and the shower head 53 can be switched between ON and OFF. By operating the other one of the handles 56, the amount of discharge water can be adjusted.

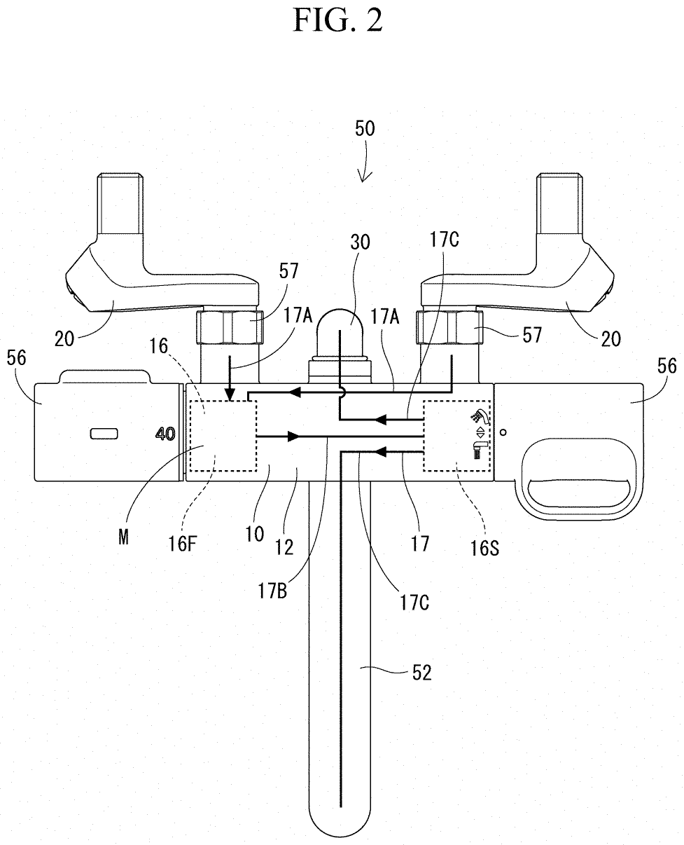

As illustrated in FIG. 2, two attachment legs 20 are attached to the back surface of the water faucet main body 10. One of the attachment legs 20 is connected to a hot water supply pipe (supply pipe) fixed to the wall surface 51 of the bathroom. Hot water is supply to the attachment leg 20 from a hot water supply source through the hot water supply pipe. The other one of the attachment legs 20 is connected to a cold water supply pipe (supply pipe) fixed to the wall surface 51 of the bathroom. Cold water is supply to the attachment leg 20 from a cold water supply source through the cold water supply pipe.

As illustrated in FIG. 2, the shower elbow 30 is attached to the back surface of the water faucet main body 10. The shower elbow 30 is disposed between the left and right attachment legs 20.

As illustrated in FIG. 2, the water faucet main body 10 includes a main body portion 12. The main body portion 12 has a cylindrical shape elongated in a left and right direction in a state of being attached to the wall surface 51 of the bathroom. The main body portion 12 includes a connection portion for the water outlet 52, the attachment legs 20, and the shower elbow 30 each. The connection portion is connected to each of the water outlet 52, the attachment legs 20, and the shower elbow 30, using a joint 57.

As illustrated in FIG. 2, the main body portion 12 accommodates two valve bodies 16F and 16S. A first valve body 16F is an adjustment valve for adjusting a mixing ratio between hot water and cold water. A function of the first valve body 16F includes closing a flow path communicating with one of inflow paths 17A described below while opening the other one of the inflow paths 17A. The second valve body 16S switches between shower water discharge, water outlet water discharge, and stop of water discharge, and adjusts the amount of discharge water. A function of the second valve body 16S includes: closing a flow path communicating with one of outflow paths 17C described below while opening a flow path communicating with the other one of the outflow paths 17C; and closing the flow paths communicating with both of the outflow paths 17C.

As illustrated in FIG. 2, a water passage 17 is provided in the main body portion 12. The water passage 17 includes the inflow paths 17A, an intermediate flow path 17B, and the outflow paths 17C. The inflow paths 17A establish communication between the attachment legs 20 and the first valve body 16F. Hot water flows in one of the inflow paths 17A and cold water flows in the other one of the inflow paths 17A. The intermediate flow path 17B establishes communication between the first valve body 16F and the second valve body 16S. The outflow paths 17C establish communication between the second valve body 16S and the water outlet 52, and between the second valve body 16S and the shower elbow 30.

Dynamic water pressure higher than supply pressure of the hot/cold water to the water passage 17 acts on the water passage 17. The supply pressure is a dynamic water pressure in an inflow portion of the attachment leg 20. Dynamic water pressure higher than the supply pressure of the cold water (cold water supply pressure) acts on the inflow path 17A in which the cold water flows. Dynamic water pressure higher than the supply pressure of the hot water (hot water supply pressure) acts on the inflow path 17A in which the hot water flows. Dynamic water pressure in the inflow paths 17A and the intermediate flow path 17B varies depending on how much the first valve body 16F and the second valve body 16S are open. When the first valve body 16F and the second valve body 16S are closed, static water pressure acts on the inflow paths 17A and the intermediate flow path 17B. When the water discharge from the shower head 53 is temporarily stopped, static water pressure acts on the outflow path 17C communicating with the shower elbow 30.

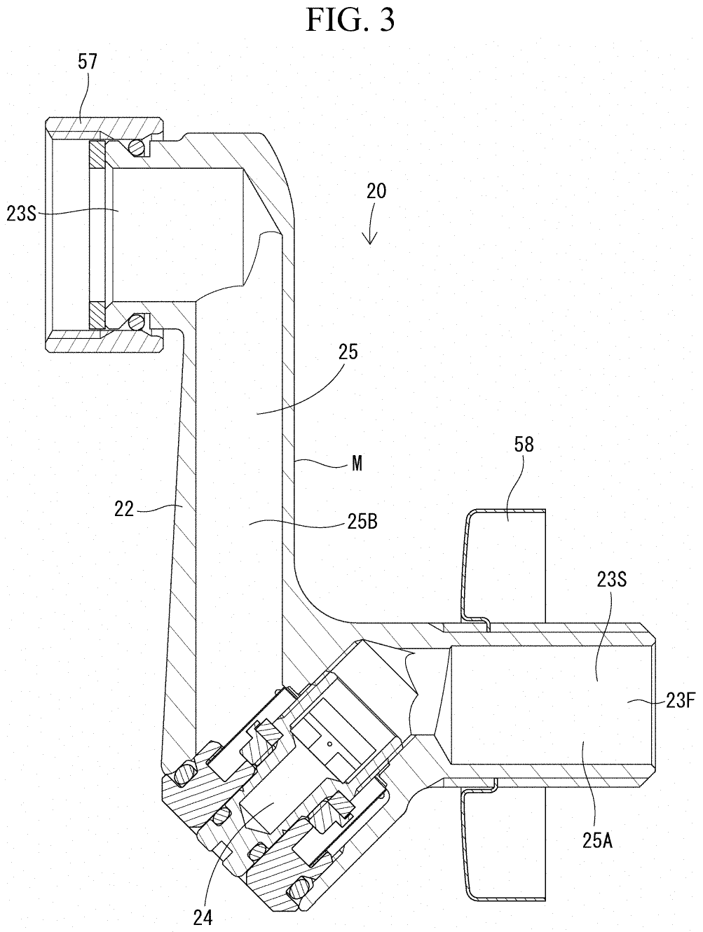

As illustrated in FIG. 3, the attachment leg 20 includes a main body portion 22. The main body portion 22 is bent in an L shape. The main body portion 22 includes two connection portions 23F and 23S. The first connection portion 23F is provided at the upstream end of the main body portion 22. The first connection portion 23F is connected to the supply pipe. The first connection portion 23F is fixed to the wall surface 51 of the bathroom using a fixing member 58. The second connection portion 23S is provided at the downstream end of the main body portion 22. The second connection portion 23S is connected to the connection portion of the water faucet main body 10.

The main body portion 22 accommodates a valve body 24 which opens and closes a water passage 25. The valve body 24 is a water stop valve. The valve body 24 of the attachment leg 20 connected to the cold water supply pipe switches cold water supply between ON and OFF. The valve body 24 of the attachment leg 20 connected to the hot water supply pipe switches hot water supply between ON and OFF.

The water passage 25 is provided in the main body portion 22. Cold water passes through the water passage 25 of the attachment leg 20 connected to the cold water supply pipe. Hot water passes through the water passage 25 of the attachment leg 20 connected to the hot water supply pipe. The water passage 25 includes an inflow path 25A and an outflow path 25B. The inflow path 25A establishes communication between the supply pipe and the valve body 24. Through the connection between the first connection portion 23F and the supply pipe, the inflow path 25A is connected to the flow path of the supply pipe. The outflow path 25B establishes communication between the valve body 24 and the water faucet main body 10. Through the connection between the second connection portion 23S and the water faucet main body 10, the outflow path 25B is connected to the inflow path 17A of the faucet main body 10.

When the valve bodies 16F and 16S disposed on the downstream side with respect to the attachment leg 20 are closed, static water pressure acts on the water passage 25. When the valve body 24 is closed, static water pressure acts on the inflow path 25A of the water passage 25. When the valve body 24 is open, dynamic water pressure higher than the supply pressure of the hot/cold water to the water passage 25 acts on the water passage 25, depending on how much the valve bodies 16F and 16S of the water faucet main body 10 are open. Dynamic water pressure higher than the cold water supply pressure during flow acts on the water passage 25 of the attachment leg 20 connected to the cold water supply pipe. Dynamic water pressure higher than the hot water supply pressure during flow acts on the water passage 25 of the attachment leg 20 connected to the hot water supply pipe.

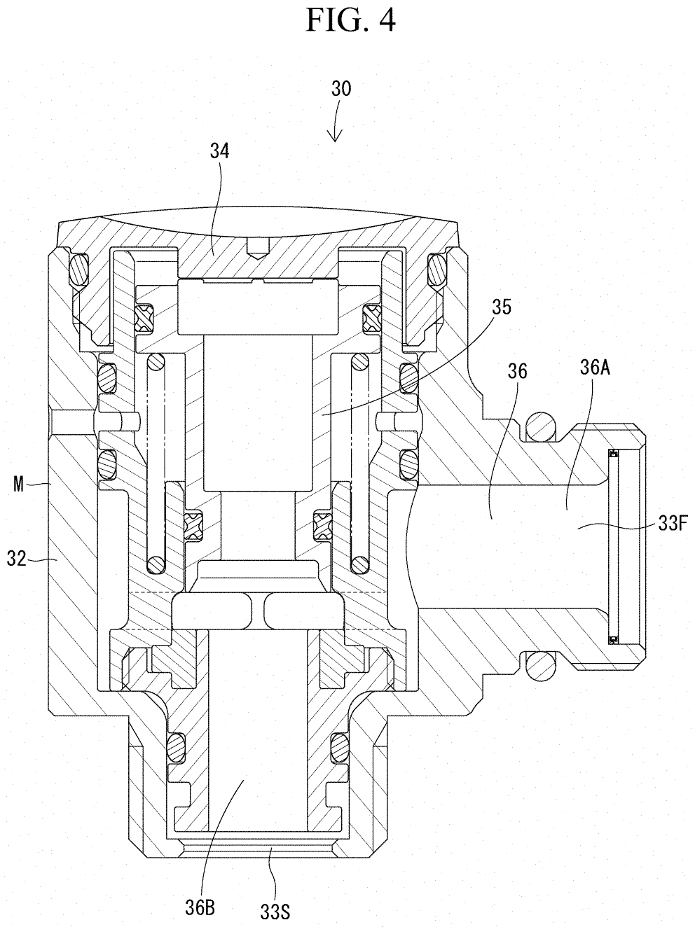

As illustrated in FIG. 4, the shower elbow 30 includes a main body portion 32. The main body portion 32 includes two connection portions 33F and 33S. The first connection portion 33F is provided at the upstream end of the main body portion 32. The first connection portion 33F is connected to the connection portion of the water faucet main body 10. The second connection portion 33S is provided at the downstream end of the main body portion 32. The second connection portion 33S is connected to the hose 54 by the joint 57. The main body portion 32 has an upper surface provided with an opening. The opening of the main body portion 32 is closed by a cap 34.

The main body portion 32 accommodates a valve body 35 which opens and closes a water passage 36. The valve body 35 is a pressure reduction valve. The valve body 35 is moved upward by elastic force of a spring. The valve body 35 reduces the water pressure on the downstream side of the valve body 35 to or below set water pressure.

The water passage 36 is provided in the main body portion 32. The water passage 36 includes an inflow path 36A and an outflow path 36B. The inflow path 36A establishes communication between the water faucet main body 10 and the valve body 35. Through the connection between the first connection portion 33F and the water faucet main body 10, the inflow path 36A is connected to the outflow path 17C of the water faucet main body 10. The outflow path 36B establishes communication between the valve body 35 and the hose 54. Through the connection between the second connection portion 33S and the hose 54, the outflow path 36B is connected to the flow path of the hose 54.

When the internal pressure of the hose 54 rises due to the temporary stop of the water discharge from the shower head 53, the valve body 35 is displaced in a direction of closing the water passage 36. When the internal pressure of the hose 54 reaches a predetermined pressure, the valve body 35 closes. Thus, increase of the pressure in the outflow path 36B is suppressed, and increase of the internal pressure of the hose 54 is suppressed.

When the water discharge from the shower head 53 is not temporarily stopped, dynamic water pressure equivalent to that in the outflow paths 17C of the water faucet main body 10 acts on the inflow path 36A and the outflow path 36B. When the water discharge from the shower head 53 is temporarily stopped, static water pressure acts on the inflow path 36A and the outflow path 36B. In a state where the valve body 35 is closed, the water pressure in the outflow path 36B is lower than the water pressure in the inflow path 36A.

The main body portion 12 of the water faucet main body 10, the main body portion 22 of the attachment leg 20, and the main body portion 32 of the shower elbow 30 are formed by engineering plastic having high mechanical strength. Examples of the engineering plastic include polyphenylene sulfide resin (PPS), polyamide (PA), polyacetal (POM), modified polyphenylene ether (m-PPE), polybutylene terephthalate (PBT), polysulfone (PSU), polyether sulfone (PES), polyether ether ketone (PEEK), polyether imide (PEI), and polyamide imide (PAI).

A plated portion M is formed on the outer surfaces of the main body portion 12 of the water faucet main body 10, the main body portion 22 of the attachment leg 20, and the main body portion 32 of the shower elbow 30. The plated portion M is formed on the outer surfaces of the main body portion 12, 22, 32 itself using a known method. For example, the plated portion M is formed on the surface of a molded products of the main body portion 12, 22, 32, which are obtained by injection molding of engineering plastic, after the surface has been treated using a solution including oxidizing agent.

The embodiment configured as described above provides the following effects. The water faucet main body 10 includes the main body portion 12. The water passage 17 for hot/cold water is formed in the main body portion 12. Pressure higher than the supply pressure of the hot/cold water to the water passage 17 during flow acts on the water passage 17. The main body portion 12 is formed by engineering plastic. The plated portion M is formed on the outer surface of the main body portion 12 itself. According to this configuration, the main body portion 12 having excellent durability is formed by engineering plastic, and the plated portion M is formed on the outer surface of the main body portion 12 itself, so that the water faucet main body 10 can have excellent outer appearance. Thus, the water faucet main body 10 can have excellent outer appearance, without molding a cover portion.

The main body portion 12 accommodates the valve bodies 16F and 16S which open and close the water passage 17. According to this configuration, when the valve bodies 16F and 16S are closed, static water pressure acts on the water passage 17. Even the water faucet main body 10 which is subject to such high water pressure can have excellent outer appearance, with the main body portion 12 having excellent durability formed by engineering plastic, and with the plated portion M formed on the outer surface of the main body portion 12 itself.

The attachment leg 20 includes the main body portion 22. The water passage 25 for hot/cold water is formed in the main body portion 22. Pressure higher than the supply pressure of the hot/cold water to the water passage 25 acts on the water passage 25. The main body portion 22 is formed by engineering plastic. The plated portion M is formed on the outer surface of the main body portion 22 itself. According to this configuration, the main body portion 22 having excellent durability is formed by engineering plastic, and the plated portion M is formed on the outer surface of the main body portion 22 itself, so that the attachment leg 20 can have excellent outer appearance. Thus, the attachment leg 20 can have excellent outer appearance, without molding a cover portion.

The main body portion 22 accommodates a valve body 24 which opens and closes a water passage 25. According to this configuration, when the valve body 24 is closed, static water pressure acts on the water passage 25. Even the attachment leg 20 which is subject to such high water pressure can have excellent outer appearance, with the main body portion 22 having excellent durability formed by engineering plastic, and with the plated portion M formed on the outer surface of the main body portion 22 itself.

The main body portion 22 includes the connection portion 23F for connection to a supply pipe through which hot/cold water is supplied from the water supply source. According to this configuration, the connection portion 23F for the supply pipe needs to have high strength. The attachment leg 20 including such a connection portion 23F can have excellent outer appearance, with the main body portion 22 having excellent durability formed by engineering plastic, and with the plated portion M formed on the outer surface of the main body portion 22 itself.

The shower elbow 30 includes the main body portion 32. The water passage 36 for hot/cold water is formed in the main body portion 32. Pressure higher than the supply pressure of the hot/cold water to the water passage 36 acts on the water passage 36. The main body portion 32 is formed by engineering plastic. The plated portion M is formed on the outer surface of the main body portion 32 itself. According to this configuration, the main body portion 32 having excellent durability is formed by engineering plastic, and the plated portion M is formed on the outer surface of the main body portion 32 itself, so that the shower elbow 30 can have excellent outer appearance. Thus, the shower elbow 30 can have excellent outer appearance, without molding a cover portion.

The main body portion 32 accommodates the valve body 35 which opens and closes the water passage 36. According to this configuration, when the valve body 35 is closed, static water pressure acts on the water passage 36. Even the shower elbow 30 which is subject to such high water pressure can have excellent outer appearance, with the main body portion 32 having excellent durability formed by engineering plastic, and with the plated portion M formed on the outer surface of the main body portion 32 itself.

The main body portion 32 is connected to the upstream side of the shower head 53 including a water stop valve. According to such a configuration, when the water discharge from the shower head 53 is stopped, high pressure acts on the main body portion 32. Such a shower elbow 30 can also have excellent outer appearance, with the main body portion 32 having excellent durability formed by engineering plastic, and with the plated portion M formed on the outer surface of the main body portion 32 itself.

The present disclosure is not limited to the embodiments described with reference to the above description and drawings, and for example, the following embodiments are also included in the technical scope of the present disclosure.
(1) In the embodiment described above, the components of the hot/cold water mixing faucet 50 are formed by engineering plastic. The present disclosure is not limited to this, and for example, a single faucet with a handle may be formed by engineering plastic.
(2) In the embodiment described above, the parts incorporating the valve body are formed by engineering plastic. The present disclosure is not limited to this. A part that does not incorporate the valve body but has a water passage receiving high pressure may be formed by engineering plastic.
(3) In the embodiment described above, the water faucet main body 10, the attachment leg 20, and the shower elbow 30 of the hot/cold water mixing faucet 50 are formed by engineering plastic. The present disclosure is not limited to this, and one or two of the water faucet main body, the attachment leg, and the shower elbow may be formed by engineering plastic.
(4) In the embodiment described above, the shower head 53 has a temporary water stop function. The present disclosure is not limited to this, and the shower head may not have the temporary water stop function.
(5) In the embodiment described above, the valve body 35 is accommodated in the shower elbow 30. The present disclosure is not limited to this and the shower elbow not accommodating a valve body may be formed by engineering plastic.

1. A water conveyance implement comprising a main body portion in which a water passage for hot/cold water is formed, wherein
pressure higher than supply pressure of the hot/cold water to the water passage during flow acts on the water passage,
the main body portion is formed by engineering plastic, and
a plated portion is formed on an outer surface of the main body portion itself.

2. The water conveyance implement of claim 1, wherein the main body portion accommodates a valve body that opens and closes the water passage.

3. The water conveyance implement of claim 1, wherein the main body portion includes a connection portion for connection to a supply pipe through which the hot/cold water is supplied from a water supply source.

4. The water conveyance implement of claim 1, wherein the main body portion is connected to an upstream side of a discharge portion including a water stop valve.
